(19) United States
(12) Patent Application Publication
(10) Pub. No.: US 2011/0117294 A1
(43) Pub. Date: May 19, 2011

(54) Biofouling prevention by induction heating

(76) Inventors: Nicholas J. Nevid, Crowley, TX (US); Edward Lee Caraway, Indialantic, FL (US); Geoffrey Swain, Melbourne, FL (US)

(21) Appl. No.: 12/927,640

(22) Filed: Nov. 19, 2010

Related U.S. Application Data
(60) Provisional application No. 61/281,551, filed on Nov. 19, 2009.

(51) Int. Cl. H05B 6/10; H05B 6/02

(52) U.S. Cl. 427/591; 219/670

(57) ABSTRACT

An apparatus and method for heating target surfaces to a temperature that inhibits, prevents or removes biofouling through induction heating includes an electromagnetic driver and control circuitry for generating electromagnetic energy within a select frequency range to match a target surface. An antenna emits the electromagnetic energy within a focused region to react with atoms/molecules in the target surface, thereby causing the target surface to be heated to a temperature within a controlled range. Increasing temperature sufficiently disrupts, kills or denatures biofouling organisms, biofilms and organic matter on the target surface and/or denatures biofilms on the surface. Coating materials may be applied to target surfaces to optimize the RF reactive molecular structure. A diagnostics, positioning and temperature sensor circuit communicates with the electromagnetic driver. A feedback circuit is used to maintain power level. Contemplated heating mechanisms include: magnetic hysteresis; dielectric hysteresis; eddy currents; and enhanced skin effect.

This non-provisional patent application is based on provisional patent application Ser. No. 61/281,551 filed on Nov. 19, 2009.

### BACKGROUND OF THE INVENTION

1. Field of the Invention

This invention relates to inductive heating and, more particularly, to an apparatus and method for heating target surfaces through inductive heating by focusing energy into a specific region or surface area that is thermally unique in contrast to the surrounding media for the purpose of controlling the unwanted accumulation of biological organisms.

2. Discussion of the Related Art

In several industries, inductive heating has been shown to be a very energy efficient approach in targeting contaminating organisms. Food sterilization is one example of a common use of inductive heating in the food preparation, processing and packaging industries. Advantageously, inductive heating is safer than electricity (especially in aquatic environments), and it is less prone to malfunctioning (i.e., does require an unbroken wiring circuit to still be effective). A field of use where inductive heating can be particular beneficial is biofouling prevention. Electromagnetic energy, coupled with specific target atoms/molecules embedded on a surface, has advantages over other methods for preventing biofouling in that it does not involve toxic chemicals, it specifically targets the organisms it is designed to kill, the target surfaces are relatively permanent (do not function by shedding or decaying), and it is cost competitive. The lower cost compared with other heating or electric methods related to biofouling is particularly significant as it relates to modifying, if necessary, the target surface. Heating of an underwater surface can be almost instantaneous, causing the target surface to boil, without a perceptible temperature change in the surrounding environment. The process of the present invention addresses the biofouling issue with minimal environmental impact using existing technological capabilities in a new way.

Biofouling of surfaces in aqueous environments (from fresh to saline) is a pervasive problem with economic consequences for many industries. The process of this invention can be adapted to almost any biofouling issue and therefore has a wide variety of applications, including (but not limited to): water crafts(e.g., ships, barges, boats); intake and discharge pipes (e.g., power plants); structural supports (e.g., oil platforms, piers, seawalls, anchors, moorings, pilings); netting (includes aquaculture cages, seines, crab traps, intake screens, and the like); transmission cables; equipment (e.g., propellers, drilling, sensors, scavengers, trawlers, scuba); plumbing (including heat exchangers or pumps, traditional household or industrial plumbing, UV filters); liquid holding (tanks, fountains, aquaria); and even mildew or lichen prone areas (showers, toilets, sinks, driveways, sidewalks, walls, floors, countertops). The process can further be adapted to non-sessile types of contaminants (biofouling) in aqueous environments, such a unwanted ciliates in algal cultures.

In addition to its use for preventing biofouling, the process of the present invention can be adapted to improve the efficiency of industries or processes requiring heating or sterilization. Examples include water heating, distillation, pasteurization and de-icing.

### OBJECTS AND ADVANTAGES OF THE INVENTION

It is the primary object of the present invention to provide an apparatus and method for heating target surfaces in a cost efficient, safe and highly efficient manner.

It is a further object of the present invention to provide an apparatus and method for controlling biofouling of underwater surfaces by heating the surfaces in a highly efficient, cost effective and safe manner.

It is still a further object of the present invention to provide an apparatus and method for controlling biofouling of underwater surfaces by heating the surfaces through induction heating.

It is still a further object of the present invention to provide an apparatus and method for controlling biofouling of underwater surfaces by focusing energy into a specific region or onto a specific surface area that is thermally unique in contrast to the surrounding media, thereby allowing the target surface area to be heated without affecting the temperature of the surrounding media if so desired.

These and other objects of the present invention are more readily apparent with reference to the detailed description and accompanying drawing.

### SUMMARY OF THE INVENTION

The apparatus and method of the present invention provides a way to remove and/or prevent biofouling on surfaces that come into contact with aquatic environments (fresh or salt). According to the invention, an electromagnetic energy source (in the frequency range of a few KiloHertz to 100s of MegaHertz) generates electromagnetic energy which is used to rapidly and efficiently heat target surfaces to temperatures sufficient to kill organisms that settle on those surfaces that are prone to biofouling. In addition to killing biofouling organisms, electromagnetic energy can also directly act to modify or remove adhesion molecules or biofilms produced by the settling organisms, further reducing the potential for colonization by biofouling organisms. Although the electromagnetic energy can be produced to match and directly target unmodified surfaces, the efficiency of the process can be improved by coating or incorporating specific atoms/molecules onto a target surface, such as non-corrosive metals or carbon nanotubes, that are known to be particularly responsive to electromagnetic energy. The frequency generated by the device would then be modified to match the optimal resonant frequency of the particular atoms/molecules that are incorporated into the target surface.

### BRIEF DESCRIPTION OF THE DRAWINGS

For a fuller understanding of the nature of the present invention, reference should be made to the following detailed description taken in conjunction with the accompanying drawings in which:

FIG. 1 is a general schematic diagram showing the primary components of the apparatus of the invention for generating and depositing electromagnetic energy into a target region or onto a target surface in order to heat the target surface in accordance with the method of the present invention.

### DETAILED DESCRIPTION OF THE PREFERRED EMBODIMENT

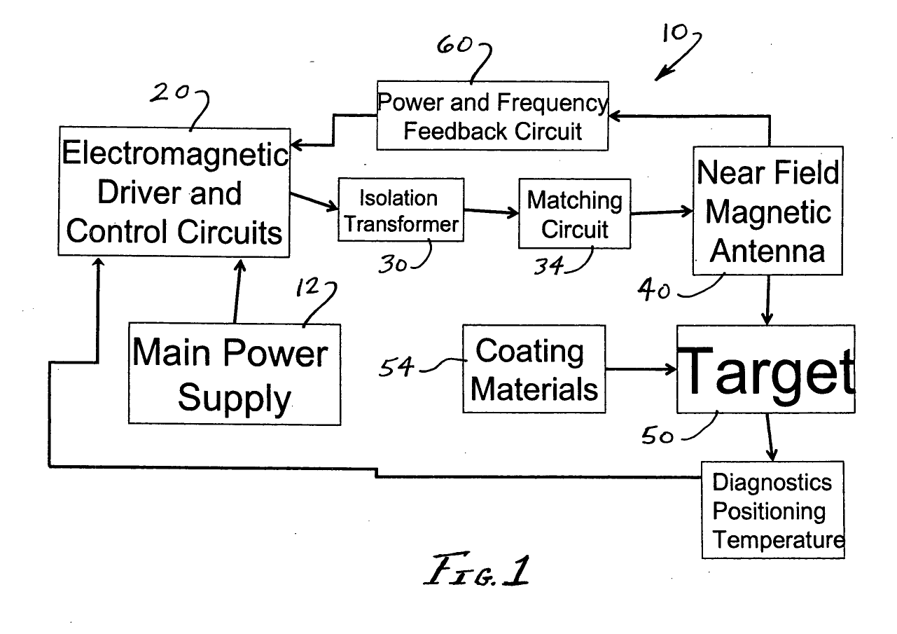

The primary components of the apparatus of this invention are shown schematically in FIG. 1 wherein the apparatus is generally indicated as 10. The apparatus 10 includes an electromagnetic device and control circuits 20 for generating electromagnetic energy. The electromagnetic device 20 is powered by a main power supply 12. The apparatus 10 further includes an isolation transformer 30 and matching circuit 34 for matching the RF field to the target field 50 that is to be heated. An antenna 40 is attached to the matching circuit 34 and emits sufficient energy, according to the matching RF, to react with target atoms/molecules within the prescribed range of the antenna 40. A power and frequency feedback circuit 60 communicates with the antenna 40 and the control circuits to allow the electromagnetic driver 20 to adjust the power and frequency of the generated electromagnetic energy as the target 50 field. The intended purpose of this energy reaction is to either increase temperature sufficiently to kill biofouling organisms or denature the biofilms these organisms create. Typical upper lethal temperatures for biofouling organisms such as crustaceans and mollusks are approximately 35-40 degrees C. It is also believed that an absolute rise of 17 degrees C. above ambient temperature, particularly if obtained rapidly, will exceed the upper thermal limit of many marine organisms. Temperatures of 50-60 degrees C. should be sufficient to denature most biofilms. For instance, power plants successfully use heated water of about 50 degrees C. to combat heavily biofouled pipes. Electromagnetic energy of sufficient intensity and appropriate frequency can also be used to cause localized chemical reactions which create substances toxic to biofouling organisms, such as high Cl-, halogen, or H2O2 concentrations. Using this process, the electromagnetic energy can be applied to the target area or surface 50 as frequently as needed to retard or prevent biofouling, since biofouling organisms are generally most vulnerable when they first settle. However, the process is also capable treating heavily biofouled surfaces. Testing of the process, using a prototype model of the invention, demonstrated rapid boiling on the surface of a target when moved into the field of the antenna, suggesting that “flash boiling” to “sterilize” a surface is definitely possible and may be the most simple strategy for certain applications.

Because the applications of the present invention are broad, both the antenna 40 and the electromagnetic energy generator 20 may or may not be submersed. In boats without ballast water, for example, both the electromagnetic energy generator 20 and the antenna 40 emitting electromagnetic energy can both be dry and mounted inside the boat. In this case, the energy waves will travel through air, penetrate through the hull of the boat, and the primary target on the outside surface (coated with appropriate material to respond to signal) exposed to water. For cleaning aquaculture nets, as another example, the electromagnetic energy generating source 20 can be above the water and connected to a submersible antenna 40. Other aquaculture situations may require both the electromagnetic energy generating source 20 and the antenna 40 to be completely submersible.

Many configurations of antennas can be attached to the electromagnetic energy generation source to optimize particular applications (e.g., signal frequency and/or wavelength, swath of field, intensity, depth of field). For many applications where a relatively simple (i.e., flat) surface is being treated, the antenna 40 may be optimized for maximum efficiency using near-field design considerations in one direction (rather than radiate out in all directions). Other applications, such as treating the inside of a pipe, may be more efficiently accomplished running the device through the pipe with an antenna 40 that radiates the electromagnetic signal in all directions.

The most efficient frequency of inductive energy used (in the frequency range of a few KiloHertz to 100s of MegaHertz) will vary depending on the resonant frequency of the target surface atoms/molecules (whether it is the inherent composition of the surface material(s) or coating materials 54 modified with specific energy absorbers) and also the type of water (predominantly salinity) where the process is being applied. Other substances may be needed in coatings that are applied to surfaces in order to insulate structural materials that are sensitive to the electromagnetic signal or high temperatures.

For non-sessile biofouling organisms, such as the contamination of algae cultures by ciliates, the energy-absorbing particles in the cooling materials 54 can be made of specific size and suitable buoyancy to specifically target the filter-feeding preferences of the target organisms.

While the invention has been shown and described in accordance with a preferred embodiment thereof, it is recognized that departures from the instant disclosure are fully contemplated within the spirit and scope of the present invention.

What is claimed is:

1. An apparatus for heating a target surface comprising:
an electromagnetic driver and control circuitry for generating electromagnetic energy within a select frequency range;
an isolation transformer and matching circuit for matching the frequency of the generated electromagnetic energy to a resonant frequency of the target surface; and
an antenna for emitting the electromagnetic energy at the matched frequency within a region to react with the target surface in a manner that causes the target surface to be heated by induction.

2. The apparatus as recited in claim 1 wherein said antenna is submersible.

3. The apparatus as recited in claim 2 wherein said antenna is a nearfield magnetic antenna.

4. The apparatus as recited in claim 2 wherein said antenna is an omni-directional antenna.

5. The apparatus as recited in claim 2 wherein said electromagnetic driver and control circuitry, said isolation transformer and said matching circuit are submersible.

6. A method for heating a target surface to inhibit, prevent and remove biofouling comprising the steps of:
providing an apparatus comprising an electromagnetic driver and control circuitry for generating electromagnetic energy, and isolation transformer and matching circuit for matching the frequency of the generated electromagnetic energy to a resonant frequency of the target surface, and an antenna for emitting the generated electromagnetic energy at the matched frequency within a region to react with the target surface in a manner that causes the target surface to be heated by induction;
determining a resonant frequency of molecules on the target surface;
generating electromagnetic energy;
matching the frequency of the generated electromagnetic energy to the resonant frequency of the molecules on the target surface;
directing the electromagnetic energy at the matched frequency onto the target surface; and
causing the target surface to be heated by induction.

7. The method as recited in claim 6 further comprising the steps of:
applying a coating to the target surface, the coating containing molecules of at least one element having properties that are particularly responsive to electromagnetic energy; and
matching the generated electromagnetic energy to an optimal resonant frequency to react with the molecules in the coating for generating heat by induction.
